(19) United States
(12) Patent Application Publication
(10) Pub. No.: US 2003/0097427 A1
(43) Pub. Date: May 22, 2003

(54) Multiple device configuration and upgrade for imaging devices

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/990,025

(22) Filed: Nov. 21, 2001

(51) Int. Cl. G06F 15/177

(52) U.S. Cl. 709/220

(57) ABSTRACT

Apparatus and methods that allow for the configuration and upgrade of single or multiple imaging devices on a network, utilizing the configuration from a pre-configured imaging device. This allows the administrator to quickly and easily upgrade multiple imaging devices on a network with software, firmware, supplemental information, specific configuration parameters, or a baseline global configuration by simply configuring a single device and upgrading the other devices from it. This allows for a new device to be easily added to an existing network by simply mirroring the configuration of a similar imaging device already on the network. This further allows for new imaging devices to be quickly added to the network by mirroring the configuration of an existing imaging device on the network.

### TECHNICAL FIELD OF THE INVENTION

The present invention relates generally to printing and imaging device configuration and management and in particular the present invention relates to multiple device upgrades of printing and imaging devices.

### BACKGROUND OF THE INVENTION

Computing devices are typically coupled to networks in modern computing environments. Networks in this definition include fiber optic, wire, wireless, and virtual, such as a virtual private network (VPN). In particular, printing and imaging devices, such as projectors, displays, and scanners are typically networked in modern computing environments. These printing and imaging devices are typically set up and configured with a built in user interface, or are configured remotely over the network. In this disclosure imaging devices are intended to include, but are not limited to, printers, multi-function copiers, digital projectors, faxes, terminals, and other such imaging devices.

When being configured over the network, the imaging devices generally require a specialized management facility, program, or protocol to interface with. These specialized management facilities, programs, or protocols are generally referred to herein as management facilities. The management facilities are typically specific to the device, class of device, or even device manufacturer, that is being managed or communicated to. This narrowness of use with existing management facilities can cause issues with ease of management of the imaging devices. However, management facilities for imaging devices can take many forms. In this disclosure, management facilities are intended to include, but are not limited to, programs running on “master” imaging devices, programs running on imaging devices with embedded webservers, management programs, and software drivers, and other such devices and programs running on alternative platforms.

Many networked imaging devices are regularly upgraded with firmware/software or configured with options specific to the device, its location, or its specific utilization on the network. Networked imaging devices can be, and typically are, of many device types, brands, and models. However, in many cases there exist multiple devices, or similar devices, that share common configuration, firmware, software, and supplemental information on a given network. Another common practice is to add a similar or identical imaging device to those currently existing on the network that must be configured with the common configuration, firmware, software, and supplemental information of the currently existing imaging devices on the network. In addition, organizational and network wide common device configurations, where a common baseline configuration is established across all devices or a class of devices, are also a standard practice. This is particularly the case among imaging devices of a similar type, model, or manufacturer.

In applying a common or baseline configuration to a network of imaging devices, the administrator individually updates each imaging device on the network. Similarly, for updates of multiple imaging devices of an identical or similar type, an administrator generally configures and updates each individual device separately. In adding a new device to a network, each new imaging device is typically configured in an almost entirely manual manner. Each of these procedures is involved, time consuming, and repetitive for the administrator.

FIG. 1 details a simplified diagram of a network and imaging device system as background. FIG. 1 includes a network backplane 100, imaging devices 102, a server 106, a workstation 108, and a management facility 110. Each imaging device 102 contains a processor or processing facility and is coupled to the network backplane 100 with a network interface. Each imaging device 102 also contains device configuration information, device firmware and software, and gathers its own usage information and statistics, which can include such information as number of pages imaged, number of jobs received, number of copies of jobs received, and numbers of errors. The management facility 110 allows management and querying of the imaging devices 102 across the network. Each imaging device 102 can have its configuration parameters, firmware, software, and supplemental information upgraded on an individual basis by an administrator utilizing the management facility 110 across the network backplane 100. Each upgrade or configuration change of each imaging device 102 is individually managed and entered by the administrator utilizing the management facility 110.

For the reasons stated above, and for other reasons stated below which will become apparent to those skilled in the art upon reading and understanding the present specification, there is a need in the art for a method of conveniently communicating to, managing, and upgrading multiple imaging devices in a network environment.

### SUMMARY OF THE INVENTION

The above-mentioned problems with conveniently communicating to, managing, and upgrading multiple imaging devices on a network are addressed by the present invention and will be understood by reading and studying the following specification.

In one embodiment, an imaging device comprises a network interface adapted for coupling to a network, and a processing facility, wherein the processing facility is adapted to request a configuration from a second imaging device through the network interface in response to receiving an external upgrade command and a network location of the second imaging device.

In another embodiment, a computer-usable medium has computer-readable instructions stored thereon for execution by a processor to perform a method. The method comprises communicating with a first imaging device having a configuration, communicating with a defined list of second imaging devices, each second imaging device having a configuration, and directing the second imaging devices to update their configuration using the configuration of the first imaging device in a manner selected from the group consisting of: retrieving the configuration from the first imaging device, storing the configuration of the first imaging device in a storage location, and directing each of the second imaging devices to retrieve the configuration of the first imaging device from the storage location; and directing each of the second imaging devices to retrieve the configuration from the first imaging device.

In a further embodiment, a method of updating configuration for imaging devices connected to a network comprises defining a list of similar imaging devices connected to the network, defining a network location associated with the desired configuration for the list of similar imaging devices, and directing each imaging device of the list of similar imaging devices to retrieve the configuration from the network location.

In yet another embodiment, a method of upgrading an imaging device with a network interface comprises receiving an external upgrade command and a network location associated with a desired configuration for the imaging device, and retrieving the desired configuration from the network location.

### BRIEF DESCRIPTION OF THE DRAWINGS

FIG. 1 is a simplified diagram of a network with imaging devices, workstation, server, and management facility.

FIGS. 2A, 2B, 2C, and 2D are simplified diagrams of configuration data being uploaded to an imaging device in accordance with embodiments of the present invention.

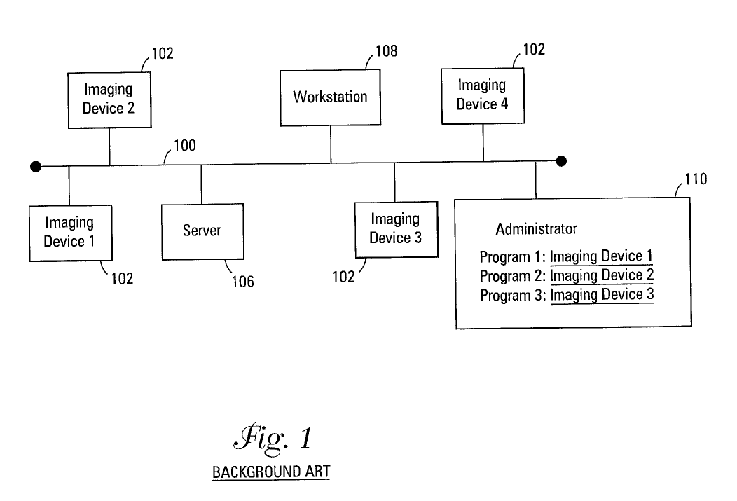

### DETAILED DESCRIPTION OF THE INVENTION

In the following detailed description of the preferred embodiments, reference is made to the accompanying drawings that form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

Embodiments of the present invention include computer networks containing a management facility and imaging devices that allow for the configuration and upgrade of multiple imaging devices on the network utilizing the configuration from a single pre-configured imaging device. This allows the administrator to quickly and easily upgrade multiple imaging devices on a network with software, firmware, supplemental information, specific configuration parameters, or a baseline global configuration by simply configuring a single device and upgrading the other devices from it. These methods additionally allow a new device to be easily added to an existing network by simply mirroring the configuration of an imaging device already on the network. As stated above, for purposes of this disclosure, networked imaging devices include, but are not limited to, printers, multi-function copiers, digital cameras, digital projectors, fax machines, and so forth. In this disclosure, the term configuration is intended to include, but is not limited to, imaging device configuration parameters, firmware, software, and supplemental information (such as help files, and diagnostics), in addition to other such imaging device parameters and upgrades in the form of programmable information.

As described above, embodiments of the present invention allow for upgrade and configuration of one or more imaging devices on a network from a single pre-configured imaging device. Several possible base embodiments of the present invention exist, primarily differing in the network site that the target imaging devices pull the upgrade configuration information from. In one embodiment of the present invention, a management facility commands the target imaging device(s) to contact the pre-configured source imaging device and upgrade themselves from its configuration. In another embodiment of the present invention, the management facility queries the pre-configured source imaging device, collecting its configuration data and storing it locally to the management facility itself. The management facility then commands the target imaging device(s) to contact the network address or network location of the management facility and upgrade themselves from the configuration data there. In yet another embodiment of the present invention, the management facility queries the pre-configured source imaging device, collecting its configuration and storing on a specified local network site. The management facility then contacts the target imaging device(s) and commands them to contact the address of the network site and upgrade themselves from the collected configuration data there. In further embodiment of the present invention, the management facility queries the pre-configured source imaging device, noting its configuration. The management facility then contacts the target imaging device(s) and commands them to contact a remote network site or website where the configuration exists and upgrade themselves to match the configuration of the source imaging device. This embodiment is particularly useful when upgrading device firmware or software. An example of such a remote network site is the universal resource locator (URL) for a website.

In upgrading an imaging device, all of the configuration, or any sub-portion thereof, can be selected to be upgraded. This includes configuration parameters, firmware, software, or supplemental data and any sub-portions of these areas. When upgrading configuration parameters, a “mask” can be specified to allow for exclusion of selected configuration parameters when loading parameters in bulk. This allows for the upgrade of an imaging device while keeping local configuration parameters that may be specific to the device, such as network identifier, controller, network interface type, communication parameters, and locally set modes such as duplexing, image quality, and power or economy modes.

Multiple communication protocols can be used in communicating with and upgrading the imaging devices, including, but not limited to, printer management language (PML), transmission control protocol/internet protocol (TCP/IP), hypertext transmission protocol (HTTP), etc. Use of such protocols to communicate upgrade requests and information is well understood in the art and will not be detailed herein.

In embodiments of the present invention, the management facility may be a function of a network device, such as a master imaging device, server, workstation or other similar device. The management facility is generally a software program running on some platform or operating system, but such functionality could be expressed in firmware or even hard-coded in a device such as an application-specific integrated circuit (ASIC) chip. Imaging devices that incorporate an embedded management facility are also known. An example of such are imaging devices with embedded webservers, allowing management of themselves and other imaging devices on the network through the embedded webserver, are described in the U.S. Patent Application Serial No. (Attorney Docket No. 10008080-1), which is commonly assigned and is incorporated herein by reference. In general, however, the management facility includes a set of computer-readable instructions stored on a computer-usable medium for execution by a processor. Examples of computer-usable medium include removable and non-removable magnetic media, optical media, dynamic random-access memory (DRAM), static random-access memory (SRAM), read-only memory (ROM) and electrically-erasable and programmable read-only memory (EEPROM or Flash).

Network sites for the purposes of this disclosure include, local and remote network sites (such as servers, workstations, and network devices), websites, network addresses or network locations of other imaging devices, and network addresses of management facilities. These network sites can communicate with a variety of protocols, including, but not limited to, the above mentioned printer management language (PML), transmission control protocol/internet protocol (TCP/IP), and hypertext transmission protocol (HTTP).

In embodiments of the present invention, when upgrading all or part of the configuration, the source imaging device is first selected utilizing the management facility. The target imaging devices, which are preferentially highly similar to the source imaging device, are selected and the configuration to be upgraded are also selected. As stated above, a “mask” can be specified if desired to allow for exclusion of selected configuration data from the upgrade for an individual device or on a group-wide basis. This is useful in keeping portions of the configuration of selected devices static and is particularly useful in keeping local device and mode configuration parameters unchanged, allowing upgrade without the need for reconfiguration of these devices. The device or devices to be upgraded are then contacted by the management facility and individually ordered to upgrade their internal versions of configuration from a source of configuration data. The source of configuration data can be the source imaging device itself, the management facility, or a reference to a local or remote network site that is specified by the management facility. The upgrade itself can then proceed under the direction of the management device or, preferentially, by the target imaging device itself, which has the benefit of offloading the management device and allowing the upgrades to occur in a highly parallel manner.

In follow-up upgrades with embodiments of the present invention, the target imaging devices, at the option of the imaging device system administrator, can periodically check the source imaging device or repository network site for changes in configuration. If a change in configuration is noted, the target imaging devices can initiate upgrade proceedings to update themselves from the source imaging device or a repository network site using the parameters of the initial upgrade operation. Alternatively, if a source imaging device is upgraded again after being initially utilized to upgrade a list of target imaging devices, it or the management facility can, at the option of the imaging device system administrator, upgrade the target imaging devices selected in the initial upgrade process.

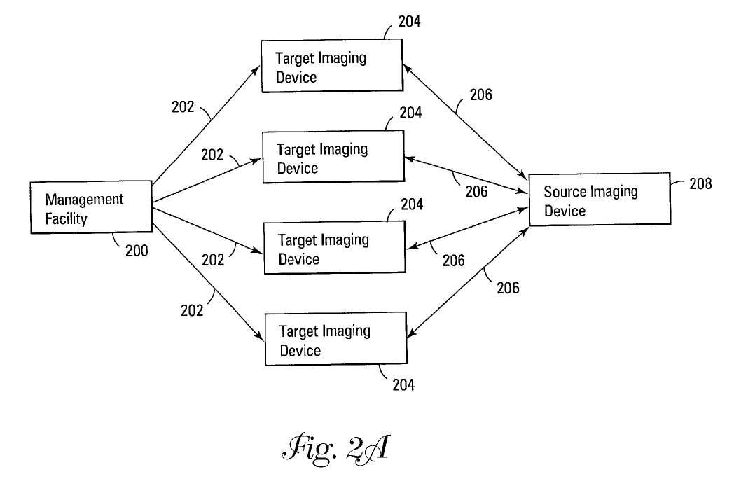

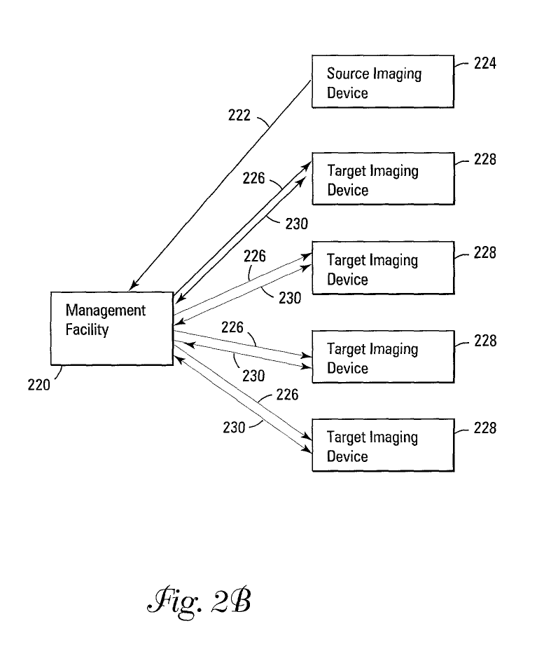

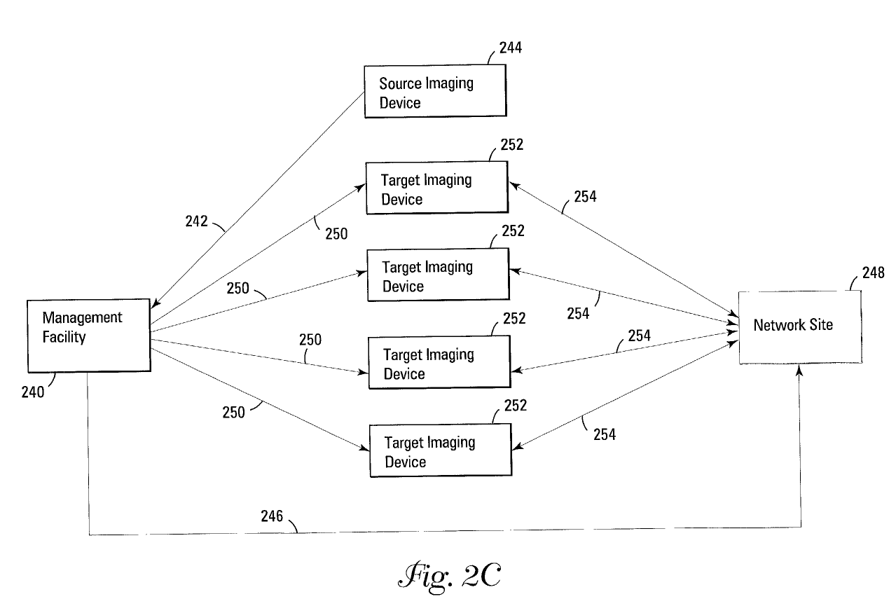

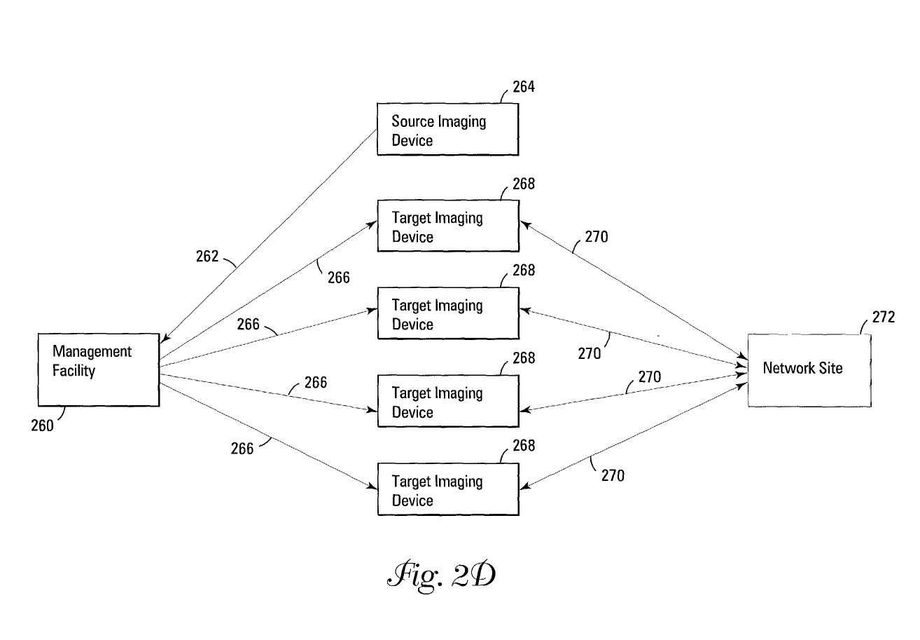

In FIG. 2A, a simplified diagram of an embodiment of the present invention is shown. In FIG. 2A, a management facility 200 defines a list of one or more of the target imaging devices 204. The management facility 200 then commands across communication links 202 the one or more target imaging devices 204 to contact across communication links 206 a pre-configured source imaging device 208 and upgrade themselves using configuration data from the pre-configured source imaging device 208.

In FIG. 2B, a simplified diagram of another embodiment of the present invention is shown. In FIG. 2B, a management facility 220 queries across communication links 222 the pre-configured source imaging device 224, collecting its configuration data and storing it locally in the management facility 220. The management facility 220 then commands across communication links 226 one or more of the target imaging devices 228 to contact across communication links 230 the network address of the management facility 220 and upgrade themselves from the configuration data held there. It is noted that communication links 226 may be the same communication links as communication links 230. In this form of upgrade, it is noted that the management facility 220 is acting as a network site holding facility for the target imaging devices 228. After being commanded to upgrade, the target imaging devices 228 internally manage their own upgrade procedure, contacting across communication links 230 the management facility 220 and pulling the upgrade to themselves by uploading the selected configuration data from the source imaging device 224. This allows the upgrade to happen more quickly by operating in parallel on the multiple target imaging devices 228 and additionally reduces the load on the management facility 220, which simply acts as a file server after the upgrade command has been given.

In FIG. 2C, a simplified diagram of an additional embodiment of the present invention is shown. In FIG. 2C, a management facility 240 queries across communication links 242 the pre-configured source imaging device 244, and collects its configuration data. The management facility 240 then places across communication links 246 the configuration data on a defined network location or site 248. The management facility 240 then contacts across communication links 250 one or more of the target imaging devices 252 and commands them to contact across communication links 254 the network site storage location 248 using the address provided through the management facility 240 and upgrade themselves from the collected configuration data there.

In FIG. 2D, a simplified diagram of a further embodiment of the present invention is shown. In FIG. 2D, a management facility 260 queries across communication links 262 the pre-configured source imaging device 264, and notes its configuration, noting configuration versions and parameters. The management facility 260 then contacts across communication links 266 one or more of the target imaging devices 268 and commands them to contact across communication links 270 to a storage location 272, such as a remote network site or website, where the configuration data and versions to match that of the source imaging device 264 and to upgrade themselves to match the configuration of source imaging device 264. As noted above, this embodiment of the present invention is particularly useful when upgrading device firmware or software.

With all embodiments of the present invention, it is preferential that the target imaging device(s) being upgraded be highly similar to the pre-configured source imaging device in manufacturer, type, and device features that the configuration data is being taken from. However, embodiments of the present invention can upgrade dissimilar imaging devices. This is particularly the case where configuration parameters are highly similar, such as where the imaging devices are dissimilar but from a single manufacturer or are built to a common standard and thus share configuration parameters or components. Examples of these highly similar configuration parameters include all non-device type specific parameters that are similar across a manufacturer, such as economy mode, network protocols, network policies, duplex modes, and other base configuration options. Configuration parameters not shared across these dissimilar devices can be masked off to avoid their corruption. Alternatively, a configuration conversion mapping function can be maintained by the management facility to convert the configuration parameters selected from the source device to configuration parameters the target imaging device type will accept. This allows for a common base configuration to be easily propagated across an imaging device system that incorporates multiple dissimilar imaging device types and manufacturers.

In addition, dissimilar imaging devices can also be upgraded by maintaining or contacting a repository network site that contains the latest relevant upgrades or pre-configured upgrade “packages” for all imaging devices on the network. The individual target imaging device(s) can then be commanded to upgrade with the appropriate configuration data for the imaging device type to make it similar to the source imaging device in function. In an example of such an upgrade, the target imaging device would be given a network address for the repository network site and the location, such as a directory location, of the upgrade configuration data at the repository network site.

Alternatively, the target imaging device(s) can be commanded to select for themselves the appropriate upgrade from the network site repository to make themselves similar in function to the source imaging device. In such an upgrade arrangement the repository network site can have a predetermined structure, such as directory hierarchy, to allow the target imaging device to find the appropriate version of the configuration upgrade files. Alternatively, the repository network site could contain an index file or database that indicates the location of the appropriate version upgrade files for the device manufacturer, type, and desired features. An example of such a dissimilar device upgrade is adding an embedded webserver functionality to a facsimile (fax) machine and then commanding a series of printers to upgrade themselves to also incorporate embedded webservers.

It is noted that alternative manners of multiple imaging device upgrade utilizing embodiments of the present invention are possible and should be apparent to those skilled in the art with the benefit of the present disclosure.

Conclusion

Various apparatus and methods are described that allow for the configuration and upgrade of single or multiple imaging devices on a network, based on the configuration from a pre-configured imaging device. This allows the administrator to quickly and easily upgrade multiple imaging devices on a network with software, firmware, supplemental information, specific configuration parameters, or a baseline global configuration by simply configuring a single device and upgrading the other devices based on its configuration. Additionally, this allows for a new device to be easily added to an existing network by simply mirroring the configuration of a similar printing or imaging device already on the network.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An imaging device comprising:
a network interface adapted for coupling to a network; and
a processing facility, wherein the processing facility is adapted to request a configuration from a second imaging device through the network interface in response to receiving an external upgrade command and a network location of the second imaging device.

2. The imaging device of claim 1, wherein the configuration from the second imaging device is requested from a storage location that is selected from the group consisting of: the second imaging device, a local network site, a remote network site, a website, a server, and a third imaging device.

3. The imaging device of claim 1, wherein the external upgrade command is given by a management facility which resides on a platform that is selected from the group consisting of: a workstation, a server, a network device, a management interface on the imaging device, an embedded webserver in an imaging device, and a master imaging device.

4. The imaging device of claim 1, wherein the configuration from the second imaging device is selected from a group consisting of at least one of: firmware code, software code, supplemental data, and a configuration parameter.

5. The imaging device of claim 4, wherein the configuration from the second imaging device comprises at least one configuration parameter, where a mask is applied to the at least one configuration parameter to exclude portions thereof from being changed on the imaging device while being upgraded.

6. A computer-usable medium having computer-readable instructions stored thereon for execution by a processor to perform a method comprising:
communicating with a first imaging device having a configuration;
communicating with a defined list of second imaging devices, each second imaging device having a configuration; and
directing the second imaging devices to update their configuration using the configuration of the first imaging device in a manner selected from the group consisting of: retrieving the configuration from the first imaging device, storing the configuration of the first imaging device in a storage location, and directing each of the second imaging devices to retrieve the configuration of the first imaging device from the storage location; and directing each of the second imaging devices to retrieve the configuration from the first imaging device.

7. The computer usable medium of claim 6, wherein the configuration is selected from the group consisting of at least one of: firmware code, software code, supplemental data, and a configuration parameter.

8. A method of updating configuration for imaging devices connected to a network, comprising:
defining a list of similar imaging devices connected to the network;
defining a network location associated with desired configuration for the list of similar imaging devices; and
directing each imaging device of the list of similar imaging devices to retrieve the configuration from the network location.

9. The method of claim 8, further comprising:
communicating with the imaging devices connected to the network with a management facility, wherein the management facility resides on a platform that is selected from the group consisting of: a workstation, a server, a network device, a management interface on the imaging device, an embedded webserver in an imaging device, and a master imaging device.

10. The method of claim 9 further comprising:
retrieving the configuration of an imaging device similar to the list of imaging devices with the management facility; and
placing the configuration at the network location.

11. The method of claim 8, wherein the configuration is selected from the group consisting of: firmware code, software code, supplemental data, and at least one configuration parameter.

12. The imaging device of claim 8, wherein the configuration is at least one configuration parameter, and wherein a mask is applied to the at least one configuration parameter to exclude portions thereof from being changed on the imaging device while being upgraded.

13. The method of claim 8, wherein the network location is selected from the group consisting of: an imaging device similar to the list of imaging devices, a local network site, a remote network site, a website, and a server.

14. The method of claim 10, further comprising:
periodically checking for changes in configuration, and if a change is noted, initiating a follow-up update.

15. A method of upgrading an imaging device, comprising:
receiving an external upgrade command and a network location associated with a desired configuration for the imaging device; and
retrieving the desired configuration from the network location.

16. The method of claim 15, wherein the desired configuration is that of a similar imaging device.

17. The method of claim 15, further comprising:
receiving the external command from a management facility, wherein the management facility resides on a platform that is selected from the group consisting of: a workstation, a server, a network device, a management interface on the imaging device, an embedded webserver in an imaging device, and a master imaging device.

18. The method of claim 15 further comprising:
retrieving the configuration of a selected imaging device with a management facility; and
placing the configuration at the network location.

19. The method of claim 15, wherein the network location is selected from the group consisting of: an imaging device, a local network site, a remote network site, a website, and a server.

20. The method of claim 15, wherein the imaging device selects an appropriate version of the desired configuration from the network location to match its type.
